(19) United States
(12) Patent Application Publication
(10) Pub. No.: US 2026/0236297 A1
(43) Pub. Date: Aug. 13, 2026

(54) ELECTRONIC DEVICE INTERACTING WITH EXTERNAL DEVICE AND OPERATING METHOD THEREOF

(71) Applicant: SAMSUNG ELECTRONICS CO., LTD., Suwon-si (KR)

(72) Inventors: Kyungmin KANG, Suwon-si (KR); Gayong SONG, Suwon-si (KR); Jihun CHAE, Suwon-si (KR); Jaehyuk SHIM, Suwon-si (KR); Youngho CHOI, Suwon-si (KR); Taeyoung LEE, Suwon-si (KR); Chulmok LEE, Suwon-si (KR); Youngjin KIM, Suwon-si (KR)

(21) Appl. No.: 19/553,692

(22) Filed: Mar. 2, 2026

Related U.S. Application Data
(63) Continuation of application No. PCT/KR2026/002446, filed on Feb. 10, 2026.

(30) Foreign Application Priority Data
Feb. 11, 2025 (KR) 10-2025-0017417

(51) Int. Cl. G06F 9/48; H04L 67/125

(52) U.S. Cl. CPC G06F 9/4881; H04L 67/125

(57) ABSTRACT

The disclosure provides an electronic device interacting with an external device. According to an embodiment, the electronic device may identify that a first task request for an external device occurs in a first process according to execution of a first application, based on determining that a CPU priority of the first process is higher than a threshold level, generates a boost message including CPU priority information of the first process, and transmit the first task request and the boost message to the external device through the communication circuit.

### CROSS-REFERENCE TO RELATED APPLICATIONS

This application is a continuation of International Application No. PCT/KR2026/002446 designating the United States, filed on Feb. 10, 2026, in the Korean Intellectual Property Receiving Office and claiming priority to Korean Patent Application No. 10-2025-0017417, filed on Feb. 11, 2025, in the Korean Intellectual Property Office, the disclosures of each of which are incorporated by reference herein in their entireties.

### BACKGROUND

### Field

The disclosure relates to an electronic device interacting with an external device and an operating method thereof.

### Description of Related Art

In a network environment, connecting multiple small computers may be more cost-effective than a single high-performance computer. For example, multiple IoT devices in a home network may cooperate to provide a single integrated function to a user. For example, a smart doorbell may transmit a notification to a user terminal through a built-in camera and sensor when a visitor presses the doorbell or approaches nearby. At the same time, a smart lock device may be linked with the smart doorbell, and after the user verifies the visitor's identity, the user may remotely lock or unlock the door through a smartphone app or voice command. The user may open the door or verify the visitor even from outside the home, thereby enhancing security and convenience.

For IoT devices to cooperate to perform tasks, network protocol technology may be used. Based on wireless communication protocols (e.g., Wi-Fi, Zigbee, Bluetooth) and standard network architectures (e.g., MQTT, CoAP), IoT devices are capable of high-performance data communication.

The information may be provided as related art for the purpose of helping understanding of the disclosure. No assertion or determination is made as to whether any of the foregoing is applicable as background art in relation to the disclosure.

### SUMMARY

According to an example embodiment of the disclosure, an electronic device may include: a memory including at least one storage medium storing instructions and at least one processor, comprising processing circuitry, wherein at least one processor, individually and/or collectively, may be configured to execute the instructions and to cause the electronic device to: identify that a first task request for an external device occurs in a first process according to execution of a first application; based on determining that a CPU priority of the first process is higher than a threshold level, generate a boost message including CPU priority information of the first process; and transmit the first task request and the boost message to the external device through a communication circuit.

According to an example embodiment of the disclosure, an electronic device may include: a memory including at least one storage medium storing instructions and at least one processor, comprising processing circuitry, wherein at least one processor, individually and/or collectively, may be configured to execute the instructions and to cause the electronic device to: receive, through a communication circuit, a first task request including a boost message from an external device; identify a second process of a second application to process the first task, and transferring the first task request to the second process; transfer the boost message to a boost daemon performing CPU scheduling or CPU resource management; apply by a boost daemon boosting to the second process based on determining that a boosting level included in the boost message is higher than a threshold level processing the first task by the second process.

According to an example embodiment of the disclosure, a non-transitory computer-readable storage medium storing at least one computer-readable instruction may be provided. The at least one instruction, when executed by at least one processor of, comprising processing circuitry, of an electronic device, individually and/or collectively, may cause the electronic device to perform at least one operation, including: identifying that a first task request for an external device occurs in a first process according to execution of a first application; based on determining that a CPU priority of the first process is higher than a threshold level, generating a first boost message including CPU priority information of the first process; and transmitting the first task request and the first boost message to the external device using a communication circuit.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device in a network environment according to various embodiments;

FIG. 2 is a diagram illustrating an example priority inheritance operation within a single system according to various embodiments;

FIG. 3 is a diagram illustrating an example operation of an electronic device interacting with an external device according to various embodiments;

FIG. 4 is a diagram illustrating an example operation of a first electronic device adding boosting level information in case of requesting a task from a second electronic device according to various embodiments;

FIG. 5 is a diagram illustrating an example de-boosting operation of a second electronic device according to processing of a task request from a first electronic device according various embodiments;

FIG. 6 is a flowchart illustrating an example operation of an electronic device transmitting a message to an external device according to various embodiments;

FIG. 7 is a flowchart illustrating an example operation of an electronic device receiving a message from an external device according to various embodiments;

FIG. 8 is a flowchart illustrating an example boosting operation of an electronic device according to a request from an external device according to various embodiments;

FIG. 9 is a diagram illustrating an example CPU scheduling adjustment operation between a display device and a source control device according to various embodiments; and

FIG. 10 is a diagram illustrating an example CPU scheduling adjustment operation between a camera device and a motor control device according to various embodiments.

Reference may be made to the accompanying drawings in the following description, and various examples that may be practiced are shown as examples within the drawings. Other examples may be utilized and structural changes may be made without departing from the scope of the various example embodiments.

### DETAILED DESCRIPTION

Hereinafter, various example embodiments of the disclosure are described in greater detail with reference to the drawings. However, the disclosure may be implemented in other various forms and is not limited to the various example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

Hereinafter, various example embodiments of the disclosure are described in greater detail with reference to the accompanying drawings.

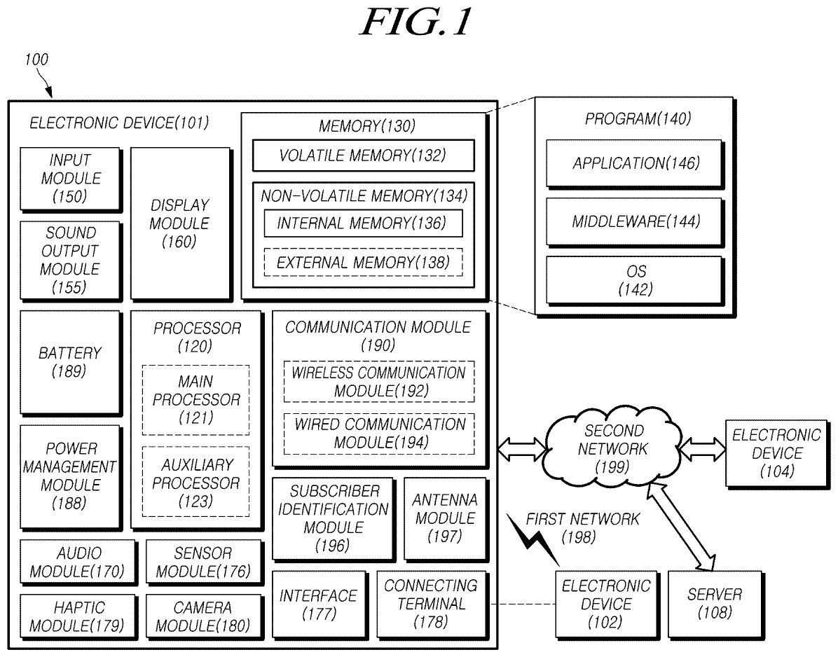

FIG. 1 is a block diagram illustrating an example electronic device in a network environment according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

An operating system is software in a computer system and may be responsible for an interface role between hardware and applications. Resources managed by the operating system include a central processing unit (CPU). CPU scheduling is a process in which the operating system determines how to allocate the CPU. Scheduling may be broadly divided into long-term, medium-term, and short-term scheduling. Long-term scheduling may determine when and which programs to load into memory. Medium-term scheduling may adjust the position of programs within memory. Short-term scheduling may determine which process to allocate the CPU to and for how long.

Short-term scheduling algorithms may include first come first serve (FCFS), shortest job first (SJF), priority scheduling, and round robin. FCFS is a method of processing in the order of arrival. SJF is a method of processing the shortest job first. Priority scheduling is a method of assigning priority to each process and processing from the highest priority process. Round robin is a method of dividing time into small units and allowing each process to occupy the CPU for a predetermined period of time.

The operating system may support an O(1) scheduler and a CFS scheduler. The O(1) scheduler supports soft real-time task execution and may operate so that tasks with higher priority have more CPU. The CFS scheduler supports fair task distribution and may operate to prevent and/or reduce low-priority tasks from falling into starvation by preventing and/or reducing high-priority tasks from preempting all CPUs. Further, the CFS scheduler may support distributing CPU resources by group through control groups (Cgroups).

The operating system may include a ‘boosting’ operation in the scheduling algorithm that supports specific tasks to use more CPU resources. The operating system may support a ‘priority inheritance boosting’ operation that boosts related tasks together. For example, in case that a high-priority task A operates together with task B, if task B finishes late due to low CPU priority, the priority inversion phenomenon where task A is also delayed may be resolved through priority inheritance boosting.

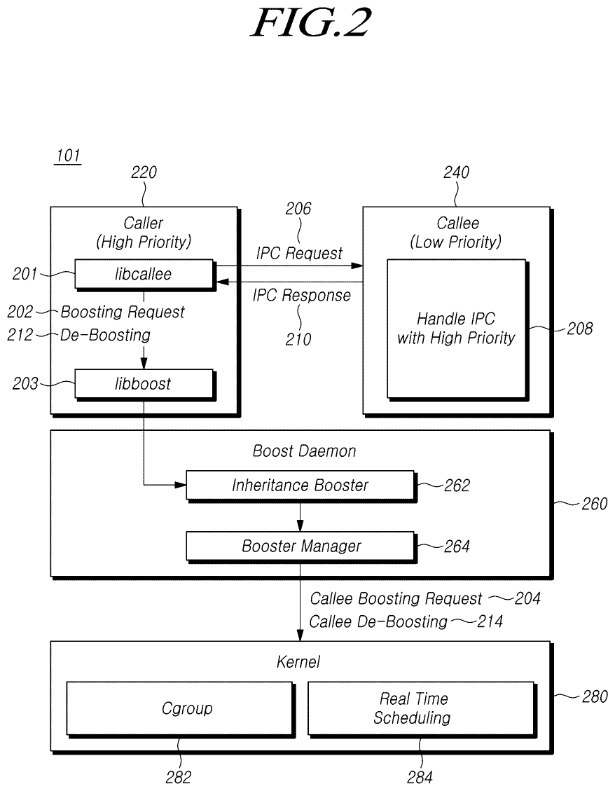

FIG. 2 is a diagram illustrating an example priority inheritance operation within a single system according to various embodiments.

Referring to FIG. 2, in a single system 101 (e.g., the electronic device 101 of FIG. 1) operated by a single operating system, a CPU scheduling priority inheritance operation may be applied to communication between processes executed at a predetermined (e.g., specified) time. According to an example, processes are associated with an application to be executed, and communication between processes may be performed through inter-process communication (IPC).

According to an example, among the processes, a first process 220, which may include to a communication requesting process, may be referred to as a Caller or IPC sending process. According to an example, among the processes, a second process 240, which may include a communication responding process, may be referred to as a Callee or IPC receiving process. Hereinafter, the first process 220 may be referred to as a Caller and the second process 240 is referred to as Callee, but the terms referring to the first process 220 and the second process 240, respectively, are not limited thereto and may be variously changed.

According to an example, the Caller 220 may have a relatively higher priority than the Callee 240, and the Callee 240 may have a relatively lower priority than the Caller 220. The Callee 240 may be previously registered as a priority inheritance target process. For example, the Callee 240 may request the boost daemon 260 to register the Callee 240 as a priority inheritance target process using a registration-related application programming interface (API).

In operation 201, the Caller 220 may call a first library 201 (hereinafter referred to as a “libcallee”) corresponding to the Callee 240.

In operation 202, when the Callee 240 is previously registered as a priority inheritance target process, the first library may request the Callee 240 to be boosted. According to an example, the boosting may include an operation of changing a scheduling policy to have a higher scheduling priority, or an operation of inheriting the higher scheduling priority. According to an example, the boosting request may be provided to the booster daemon 260 through the second library (hereinafter, referred to as a “libboost”) 203. According to an example, when the Callee 240 is registered as a priority inheritance target process and the scheduling priority of the Callee 240 is lower than the scheduling priority of the Caller 220, the boosting request may be provided to the boost daemon 260. According to an example, the boosting request may include information about the scheduling priority of the Caller 220 or information about the scheduling policy applied to the Caller 220.

The inheritance booster 262 of the boost daemon 260 may receive a boosting request provided from the Caller 220. In response to receiving the boosting request, the inheritance booster 262 may request the booster manager 264 to perform an operation (e.g., or the inheritance of the scheduling priority of the Caller 220 or the scheduling policy) for boosting the Callee 240.

A booster manager 264 may adjust the scheduling priority of the Callee 240 so that the scheduling priority of the Caller 220 is inherited by the Callee 240 in response to a request from an inheritance booster 262. For example, the booster manager 264 may change the priority of the Callee 240 to be higher than or equal to the priority of the Caller 220. The booster manager 264 may set or change the scheduling policy of the Callee 240 so that the scheduling policy applied to the Caller 220 is inherited by the Callee 240 in response to the request from the inheritance booster 262. For example, when the Cgroup policy is set for the Callee 240, the booster manager 264 may set an RT policy for the Callee 240 to release the Cgroup policy and have the same scheduling priority as the Caller 220. According to an example, the RT policy may be a scheduling policy applied to the Caller 220.

In operation 204, the booster manager 264 may provide information about the scheduling policy set for the Callee 240 to a kernel 280 as an operation requesting boosting of the Callee 240. In the kernel 280, resource allocation by the Cgroup 282 or the real-time scheduling unit 284 may be performed based on the scheduling policy set for the Callee 240. For example, when the set scheduling policy is an RT policy, the real-time scheduling unit 284 may preempt CPU resources and allocate them to the Callee 240.

In operation 206, the Caller 220 may transmit an IPC request to the Callee 240.

In operation 208, the Callee 240 may process an IPC request with a higher scheduling priority based on boosting.

In operation 210, the Callee 240 may transmit an IPC response to the Caller 220 in response to processing the IPC request.

In operation 212, the Caller 220 may request de-boosting for the Callee 240 in response to receiving an IPC response. According to an embodiment, the boosting release request may be provided to the boost daemon 260 through the libboost 203.

The inheritance booster 262 of the boost daemon 260 may receive a boosting release request provided from the Caller 220. In response to receiving the boosting release request, the inheritance booster 262 may request the booster manager 264 to perform an operation (e.g., release of the inheritance of the scheduling priority of the Caller 220 or the scheduling policy) for the boosting release of the Callee 240.

In response to the request of the inheritance booster 262, the booster manager 264 may determine whether a timeout event associated with the priority inheritance operation occurs. According to an example, the timeout event may occur a set time after the time when priority inheritance is performed. The booster manager 264 may change the priority of the Callee 240 to before inheritance so that the scheduling priority inherited by the Callee 240 is released in response to occurrence of a timeout event. For example, the booster manager 264 may lower the priority of the Callee 240 below the priority of the Caller 220, e.g., to the level before inheritance. Alternatively, the booster manager 264 may change the scheduling policy of the Callee 240 so that the scheduling policy inherited by the Caller 220 is released in response to occurrence of the timeout event. For example, the booster manager 264 may release the RT policy set for the Callee 240 and set the Cgroup policy corresponding to the low scheduling priority for the Callee 240. According to an example, the Cgroup policy may be a scheduling policy previously set for the Callee 240.

In operation 214, the booster manager 264 may provide information about the changed priority of the Callee 240 or the set scheduling policy to the kernel 280 as an operation releasing boosting of the Callee 240. In the kernel 280, resource allocation by a Cgroup 282 or a real-time scheduling unit 284 may be performed based on the priority of the Callee 240 or the scheduling policy set for the Callee 240. For example, when the scheduling policy set for the Callee 240 is a Cgroup policy, the kernel 280 may allocate CPU resources to the Callee 240 based on the resource allocation ratio corresponding to the control group including the Callee 240.

The electronic device 101 according to an embodiment may prevent and/or reduce priority inversion through priority inheritance boosting under a single operating system. However, in the case of not a single system, since each operating system operates independently, priority inheritance boosting may not operate in case of requesting tasks between heterogeneous devices.

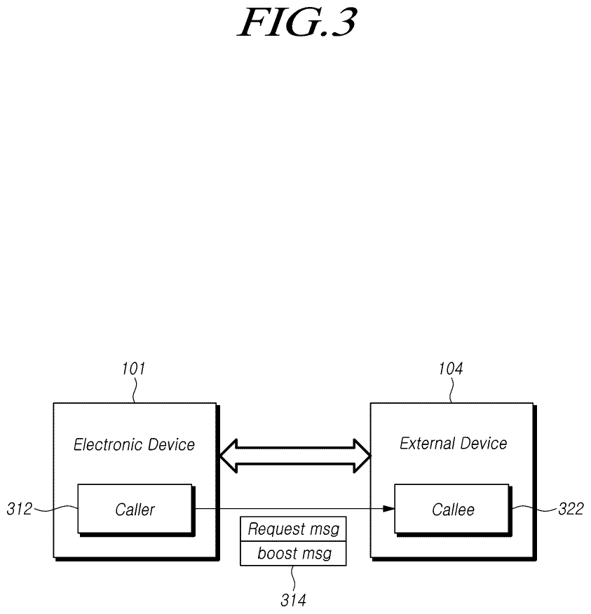

FIG. 3 is a diagram illustrating an example operation of an electronic device interacting with an external device according to various embodiments.

An electronic device 101 (e.g., the electronic device 101 of FIG. 1) according to an embodiment may interact with an external device 104 (e.g., the electronic device 104 of FIG. 1) in relation to application execution. For example, the electronic device 101 (e.g., display device) may receive graphic data from the external device 104 (e.g., source device) for game play and output it on a screen, and transmit control signals for manipulating characters or items to the external device 104. Hereinafter, for ease of description of the interaction between two devices, they are referred to as electronic device-external device, but the terms referring to each of the two interacting devices are not limited thereto and may be variously changed. For example, the electronic device-external device of FIG. 3 may be variously represented as first electronic device-second electronic device, communication requesting device-communication receiving device, task requesting device-task processing device, or data requesting device-data receiving device. Further, they may be referred to as data requesting device-data receiving device according to the interaction operation between the two devices, and the corresponding name is not fixed to any one device. For example, at a predetermined time, a first electronic device may request data from a second electronic device, and the second electronic device may receive the data request, but at another time, the second electronic device may request data from the first electronic device, and the first electronic device may receive the data request.

There are various methods for communication between the electronic device 101 and the external device 104, e.g., heterogeneous devices. Technologies that enable high-performance data communication in a network environment include DBUS (KDBUS), socket, remote procedure call (gRPC), and REST. DBUS is a message bus system designed for inter-process communication and may be applied to communication between applications and services. Similar KDBUS was implemented as a protocol running in kernel space. A socket supports communication between processes within a single system or between processes in different systems. gRPC is a remote procedure call designed to efficiently handle communication between heterogeneous devices and supports server-client based communication. Global remote procedure call (gRPC) is a technology combining HTTP/2 and serializer, enabling data communication without program restrictions in any environment. representational state transfer (REST) is an architectural style for exchanging data in web-based systems, representing resources using URLs based on HTTP and supporting communication between client and server. Unlike REST, gRPC requires a close connection between server and client and also requires synchronization of proto files. Further, since gRPC also supports bi-directional streaming functionality, it may process multiple requests and responses simultaneously. In environments with frequent network communication like microservices, gRPC may exhibit better performance than RESTful. The electronic device 101 according to an embodiment may perform inter-process communication with the external device 104 based on various network communication methods. Hereinafter, embodiments may be described using one of various communication methods as an example, but the various embodiments of the disclosure are not limited to that communication method.

Referring to FIG. 3, among the processes of the electronic device 101 according to an embodiment, a Caller 312 may request a task (or data communication) from the external device 104. Among the processes of the external device 104, a Callee 322 may process the task (or data communication) request received from the electronic device 101 and generate a response. In this case, in case that the priority of the Caller 312 is higher than a threshold level, the electronic device 101 may add a boost message to the request message and transmit it to the external device 104. For example, in case that the Caller 312 is running in the foreground, real-time processing such as screen output is required, and it may have the highest priority among running processes.

The Caller 312 and the Callee 322 are capable of task or data request and processing through inter-process network communication. According to an example, the Caller 312 may transmit a task request message to the Callee 322 through gRPC. A gRPC communication message 314 may include a task request message (request msg) and a boost message (boost msg). In case that the priority of the Caller 312 is high above a threshold level, a boost message may be transmitted to the external device 104 to request a quick response from the Callee 322. The boost message may include the boosting level of the Caller 312.

In case that the received gRPC communication message 314 includes a boost message, the external device 104 may know the CPU scheduling priority of the Caller 312 through the boosting level of the boost message. The boost message may be transferred to a boost daemon of the external device 104. In case that the priority of the Caller 312 is higher than the threshold level, the external device 104 may adjust the priority of the Callee 322 high according to the request of the Caller 312. The Callee 322 may process the task or data communication request with high scheduling priority. The Callee 322 may return an RPC response to the Caller 312 as a response to processing the task or data communication request.

Even in case that the CPU priority of the Callee 322 is low, the external device 104 may adjust the CPU resource distribution priority within the external device 104 according to the request of the Caller 312. Accordingly, the process task request and processing between heterogeneous devices may have the same effect as the priority inheritance boosting operation within a single system.

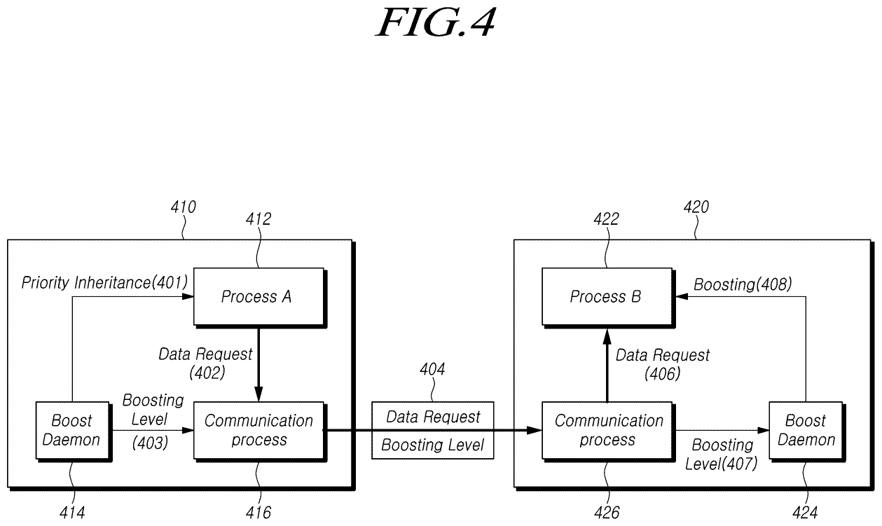

FIG. 4 is a diagram illustrating an example operation of a first electronic device adding boosting level information in case of requesting a task from a second electronic device according to various embodiments.

A first electronic device 410 (e.g., the electronic device 101 of FIG. 3) according to an embodiment may include a process A 412 of a running application or service, a boost daemon 414, and a communication process 416. A second electronic device 420 (e.g., the external device 104 of FIG. 3) may also include a process B 422 of a running application or service, a boost daemon 424, and a communication process 426. Components with the same name included in the first electronic device 410 and the second electronic device 420 may include at least some of the functions described below. In other words, the boost daemon 424 of the second electronic device 420 may include technical features of the boost daemon 414 of the first electronic device 410.

The boost daemon 414 may perform CPU scheduling and/or CPU resource management. According to an example, the boost daemon 414 may include an app state listener, an inheritance booster, a service booster, a generic booster, a netlink handler, and a booster manager. The app state listener may receive events associated with the lifecycle of an application (e.g., application execution event). The app state listener may identify whether the corresponding application is in a visible state or not based on the app state. The inheritance booster may perform operations for priority inheritance between processes having different priorities. For example, the inheritance booster may request the booster manager to set (or change) a scheduling policy for a low-priority process to inherit the priority of a high-priority process. The service booster may manage CPU resource allocation of a service process. The service process may provide functions necessary for the operation of a service (or application) and may be one or more. The generic booster may optimize resource allocation of a service process. The netlink handler may receive events associated with the lifecycle of a process. The booster manager may set a CPU policy (or CPU scheduling method), allocate control groups, determine resource allocation ratios, or set CPU resource allocation priorities. The boost daemon 414 is capable of CPU scheduling for processes running inside the first electronic device 410. The boost daemon 424 is capable of CPU scheduling for processes running inside the second electronic device 420. Since the first electronic device 410 and the second electronic device 420 are not a single system, the second electronic device 420 may not know the priority of internal processes of the first electronic device 410, and the priority of internal processes of the first electronic device 410 may not be inherited by processes of the second electronic device 420.

The communication process 416 may communicate with an external device (e.g., the external device 104) through high-performance data communication technology (e.g., remote procedure call (RPC), gRPC). In an example, gRPC is a technology for calling functions (procedures) through a network between different devices or processes. As if executing a function in a local environment, the function may be executed on a remote device through the network and the result may be returned. RPC operates based on a client-server model, and in an example, the first electronic device 410 and the second electronic device 420 may function as client-server respectively. The communication process 416 may perform serialization for a task request to the second electronic device 420 and transmit it to the second electronic device 420. The communication process 426 of the second electronic device 420 may deserialize the task request received from the first electronic device 410 and transfer it to an internal process that will process the corresponding task request.

Referring to FIG. 4, according to the CPU priority of a process during application execution, the first electronic device 410 according to an embodiment may include information (e.g., boosting level) indicating the process priority of the electronic device 410 in a data request message to the second electronic device 420.

In operation 401, the boost daemon 414 may apply priority inheritance to the process A 412. The process A 412 may have a CPU scheduling priority higher than a threshold level. For example, the process A 412 may be running in a foreground state. According to priority inheritance, boosting may be applied to processes related to the process A 412.

In operation 402, the process A 412 may transfer a data request message to the communication process 416 to request data or a task from the second electronic device 420. In case that the process A 412 requests a service or data requiring a response from the second electronic device 420, it may request with a synchronous call (sync call). Alternatively, in case that the process A 412 makes a service request not requiring a response from the second electronic device 420, it may request with an asynchronous call (async call).

In operation 403, the communication process 416 may identify the boosting level of the process A 412 that requested message transmission to the second electronic device 420 through the boost daemon 414. The boost daemon 414 may transfer boosting level information of the process A 412 to the communication process 416.

In operation 404, based on network communication (e.g., gRPC), the communication process 416 may transmit a message including a data request and boosting level information to the communication process 426 of the external device 104. In case that the process A 412 makes a synchronous call requiring a response from the second electronic device 420, the communication process 416 may include boosting level information in the boost message. In case that the process A 412 makes an asynchronous call not requiring a response from the second electronic device 420, the communication process 416 may include information about timeout in the boost message. The timeout may define a duration so that resources are not wasted for a long time processing the corresponding task in the second electronic device 420.

In case that the communication process 426 of the second electronic device 420 receives a message from the first electronic device 410, it may identify whether boosting level information or timeout information is included in addition to the data request. In case that boosting level information or timeout information is included, the communication process 426 may transfer the boosting level information or timeout information to the boost daemon 424 (operation 407). The communication process 426 may transfer the corresponding data request to the process B 422 that will process it (operation 406). The data request message may include information about the related application or service, and the communication process may identify the process B 422 based on that information.

In operation 408, in case that the received boosting level of the process A 412 is higher than a threshold level, the boost daemon 424 may perform boosting on the process B 422. For example, the boost daemon 424 may change the CPU scheduling priority of the process B 422 high while the process B 422 processes the data request of the process A 412. The process B 422 may process the data request of the process A 412 with high scheduling priority based on boosting. Although the second electronic device 420 may not know the priority of the process A 412 and may not inherit the priority of the process A 412, by including priority information of the process A 412 in the inter-process communication message and transferring it, and having the received message processed by the boost daemon 424, it may identify the priority of the process A 412 and apply boosting operation to the related process B 422 accordingly.

In case that the process A 412 requested data or a task from the second electronic device 420 but determines that the task is not needed, it may transmit a boost message canceling the previously transmitted boost message to the second electronic device 420. While the second electronic device 420 applies boosting to the process B 422 at the request of the process A 412, in case that it receives a boost message canceling the corresponding boosting, it may immediately release the boosting application to the process B 422.

An electronic device 410 according to an example embodiment may include a communication circuit, a memory including at least one storage medium storing instructions, and at least one processor including processing circuitry.

According to an example embodiment, the electronic device 410 may identify that a first task request for an external device 420 occurs in a first process 412 according to execution of a first application, based on determining that a CPU priority of the first process 412 is higher than a threshold level, a communication process 416 generates a boost message including CPU priority information of the first process 412, and transmit the first task request and the boost message to the external device 420 through the communication circuit.

According to an example embodiment, the electronic device 410 may identify a boosting level of the first process 412 through a boost daemon 414 performing CPU scheduling or CPU resource management of the electronic device 410, and include the boosting level in the boost message.

According to an example embodiment, the electronic device 410 may set the boost message to be transmitted to a boost daemon 424 performing CPU scheduling or CPU resource management of the external device 420.

According to an example embodiment, in case that the first task does not require a response from the external device 420, the electronic device 410 may set to include a timeout event in the boost message.

According to an example embodiment, in case that the first task requires a response from the external device 420, the electronic device 410 may set generation of a response according to completion of the first task as a de-boosting condition in the boost message.

According to an example embodiment, after transmitting the first task request message, based on determining that the first task request is not needed, the electronic device 410 may generate a de-boost message releasing a previous boost message, and transmit the de-boost message to the external device 420 through the communication circuit.

According to an example embodiment, the electronic device 410 may transmit the first task request and the boost message based on any one method of DBUS, KDBUS, socket, or gRPC.

An electronic device 420 according to an example embodiment may include a communication circuit, a memory including at least one storage medium storing instructions, and at least one processor including processing circuitry.

According to an example embodiment, the electronic device 420 may receive a first task request including a boost message from an external device 410 through the communication circuit, identify a second process 422 of a second application to process the first task and transfer the first task request to the second process 422, transfer the boost message to a boost daemon 424 performing CPU scheduling or CPU resource management, the boost daemon 424 applies boosting to the second process based on determining that a boosting level included in the boost message is higher than a threshold level, and the second process 422 may process the first task.

According to an example embodiment, the electronic device 420 may determine that the boost daemon 424 does not apply boosting to the second process 422 based on determining that the boosting level included in the boost message is not higher than the threshold level.

According to an example embodiment, in case that the second application is not running, the electronic device 420 may execute the second application and register the second process 422 as related to the external device 410.

According to an example embodiment, in case that a timeout event is included in the boost message, the electronic device 420 may allow the timeout event to proceed from a time when the boosting operation of the second process 422 is performed, and release the boosting operation of the second process 422 in response to completion of the timeout event.

According to an example embodiment, the electronic device 420 may release the boosting operation of the second process 422 in response to the second process 422 processing the first task and generating a response.

According to an example embodiment, the electronic device 420 may receive a de-boost message for the first task request from the external device 410 through the communication circuit, transfer the de-boost message to the boost daemon 424, and the boost daemon 424 may release the boosting operation of the second process 422 in response to receiving the de-boost message.

According to an example embodiment, the electronic device 420 may receive the first task request including the boost message based on any one method of DBUS, KDBUS, socket, or gRPC.

According to an example embodiment, the electronic device 420 may determine whether the second process 422 has high relevance with currently running processes, and in response to determining that the second process 422 has high relevance with currently running processes, set the boosting level of the second process 422 equal to the boosting level of the running process.

According to an example embodiment, in response to determining that the second process 422 does not have high relevance with currently running processes, the electronic device 420 may determine whether the first task is displayed to a user, and in response to determining that the first task is displayed to the user, set the boosting level of the second process 422 equal to the boosting level of real-time level processes.

According to an example embodiment, in response to determining that the first task is not displayed to the user, the electronic device 420 may set the boosting level of the second process 422 lower than the boosting level of real-time level processes.

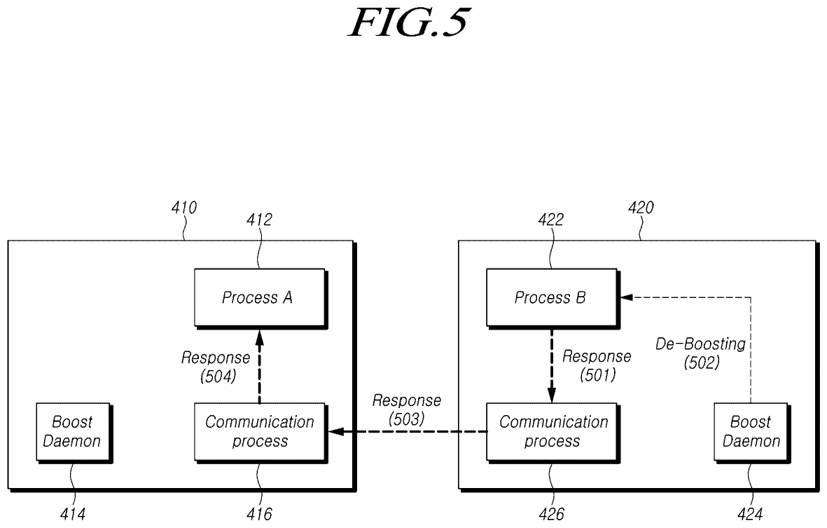

FIG. 5 is a diagram illustrating an example de-boosting operation of a second electronic device according to processing of a task request from a first electronic device according to various embodiments.

The second electronic device 420 according to an embodiment may receive a task request from the first electronic device 410 and perform a boosting operation for the process B 422 that processes it (e.g., operation 408 of FIG. 4). The operation of FIG. 5 may be connected to operation 408 of FIG. 4.

In operation 501, the process B 422 may process the task request of the process A 412 and transfer a response to the communication process 426.

In operation 502, the boost daemon 424 may release boosting for the process B 422. There may be one or more de-boosting conditions. For example, the boost daemon 424 may release boosting in case that a timeout event is set, in case of receiving a de-boosting request from the process A 412, or in case that the process B 422 completes the requested task. The boost daemon 424 may identify whether a timeout event associated with the boosting operation of the process B 422 occurs. The timeout event may occur after a set time from the time point when the boosting operation for the process B 422 is performed. In response to occurrence of the timeout event, the boost daemon 424 may change the priority of the process B 422 adjusted at the request of the process A 412 back to before boosting. Alternatively, the boost daemon 424 may release boosting of the process B 422 as the process B 422 transfers a response message processing the requested task to the communication process 426.

In operation 503, the communication process 426 may transmit a response to the communication process 416 of the first electronic device 410.

In operation 504, the communication process 416 of the first electronic device 410 may transfer the received response to the process A 412.

While the process A 412 of the first electronic device 410 has high priority, by transferring boost level information during interaction with the second electronic device 420, it may expect a quick response from the second electronic device 420.

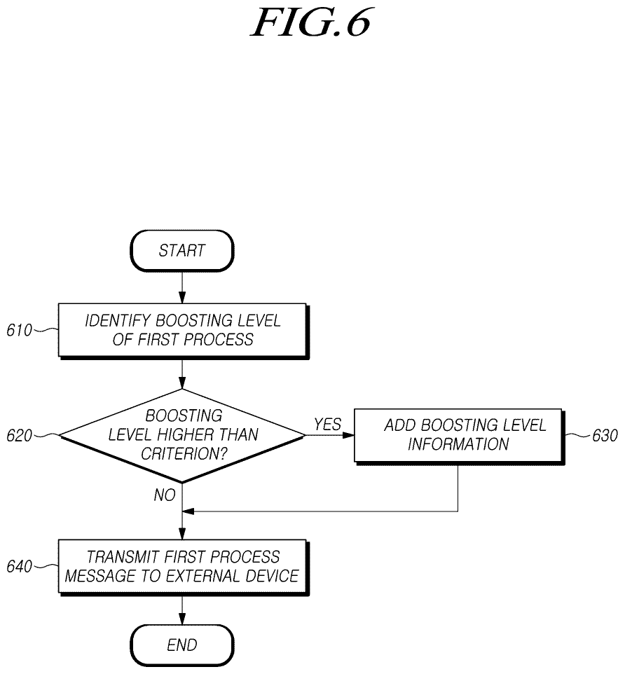

FIG. 6 is a flowchart illustrating an example operation of an electronic device transmitting a message to an external device according to various embodiments.

An electronic device (e.g., the electronic device 101 of FIG. 1, the first electronic device 410 of FIGS. 4 and 5) according to an embodiment may request a task or data from an external device (e.g., the electronic device 104 of FIG. 1, the second electronic device 420 of FIGS. 4 and 5) during application execution. In case that a first process of the electronic device 101 transfers a task request message to a communication process to make a task request to the external device 104, the communication process may add boosting level information considering the priority of the first process. Hereinafter, the operation of adding boosting level information by the communication process is described.

In the following example, each operation may be performed sequentially, but is not necessarily performed sequentially. For example, the order of the operations may be changed, and at least two operations may be performed in parallel.

In operation 610, the communication process of the electronic device 101 according to an embodiment may identify the boosting level of the first process. In case that the communication process receives a task request message for an external device from the first process, it may request boosting level information of the first process from a booster module to identify the priority of the first process. The boosting level uses a scheduling policy that may be applied to scheduling methods of the O(1) scheduler and CFS scheduler. For example, Table 1 illustrates priorities according to scheduling policies.

TABLE 1

| policy | class | priority | policy description |
|---|---|---|---|
| SCHED_FIFO | Real Time | 1 to 99 | First Come First |
| | | | Served |
| SCHED_RR | Real Time | 1 to 99 | Round Robbin |
| SCHED_{—} | Normal | 100 to 139 | Round Robbin |
| OTHER(SCHED_{—} | | | |
| NORMAL) | | | |

In Table 1, in case that a process follows the SCHED_FIFO policy, it may support real-time processing, and the priority may be set to a value between 1 and 99. SCHED_OTHER may be set to a value between 100 and 139 with lower priority than policies supporting real-time processing. Priority is set relatively among currently running processes and, in case that one process follows SCHED_FIFO and another process follows SCHED_OTHER, it may be determined that the former process has higher priority. In case that both processes correspond to SCHED_FIFO, the process that started first may have a higher priority value. The operating system may support the O(1) scheduler and the CFS scheduler, and the priority set for a process may be identified through a booster module. The communication process may identify the scheduling policy or set priority value set for the first process through the booster module. In operation 620, the communication process of the electronic device 101 according to an embodiment may determine whether the boosting level of the first process is higher than a predetermined criterion. The electronic device 101 may preset a criterion in relation to the boosting operation.

In operation 630, in case that the communication process of the electronic device 101 according to an embodiment determines that the boosting level of the first process is higher than the predetermined criterion in operation 620, it may add boosting level information to the task request message transmitted to the external device 104. The boosting level information may be set to be transferred to the boost daemon of the external device 104. The electronic device 101 and the external device 104 may agree in advance on a message transmission/reception format for boosting level information. In case that the communication process determines that the boosting level of the first process is not higher than the predetermined criterion, it may not add boosting level information.

In operation 640, the communication process of the electronic device 101 according to an embodiment may transmit the message of the first process to the external device 104. The message of the first process relates to a task request and may further include boosting level information according to operation 630.

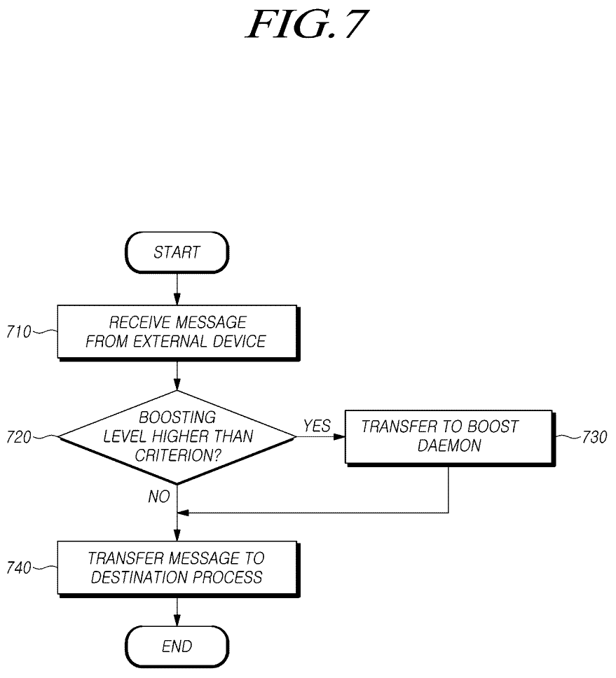

FIG. 7 is a flowchart illustrating an example operation of an electronic device receiving a message from an external device according to various embodiments.

An electronic device (e.g., the electronic device 104 of FIG. 1, the second electronic device 420 of FIGS. 4 and 5) according to an embodiment may receive a task or data request from an external device (e.g., the electronic device 101 of FIG. 1, the first electronic device 410 of FIGS. 4 and 5). In the following example, each operation may be performed sequentially, but is not necessarily performed sequentially. For example, the order of the operations may be changed, and at least two operations may be performed in parallel.

In operation 710, the communication process of the electronic device 104 according to an embodiment may receive a message from an external device.

In operation 720, the communication process of the electronic device 104 according to an embodiment may determine whether boosting level information is included in the received message and whether the boosting level is higher than a predetermined criterion. The electronic device 104 may predefine a criterion in relation to the boosting operation. The criterion for determining the boosting level may differ for each device. For example, the predetermined criterion of the electronic device 101 in operation 620 of FIG. 6 and the predetermined criterion of the electronic device 104 in operation 720 of FIG. 7 may differ.

In operation 730, in case that the communication process of the electronic device 104 according to an embodiment determines that the boosting level of the received message is higher than the predetermined criterion, it may transfer the boosting level information to the boost daemon. The boost daemon may apply a boosting operation to the destination process considering the boosting level.

In operation 740, the communication process of the electronic device 104 according to an embodiment may transfer the received message to the destination process that will process the received message.

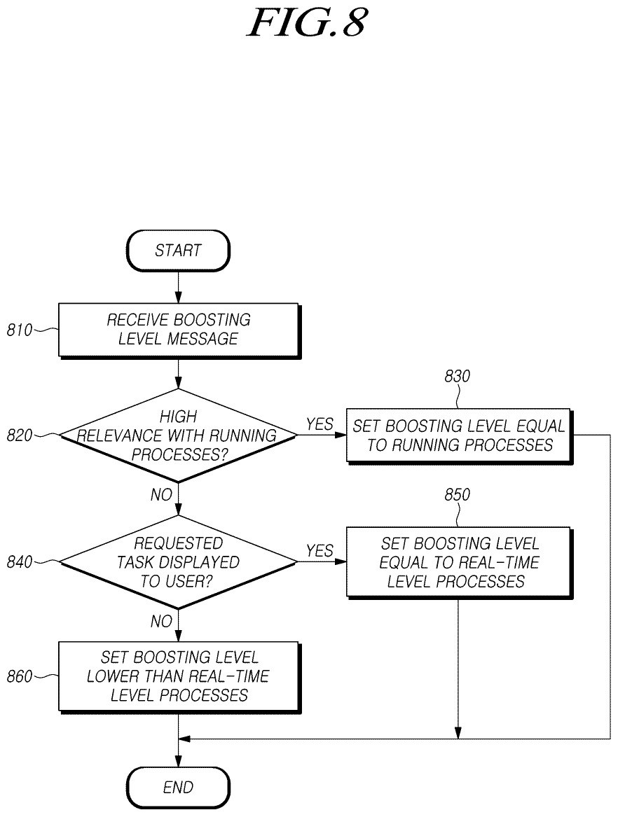

FIG. 8 is a flowchart illustrating an example boosting operation of an electronic device according to a request from an external device according to various embodiments.

In case that an electronic device (e.g., the electronic device 104 of FIG. 1, the second electronic device 420 of FIGS. 4 and 5) according to an embodiment receives a task or data request from an external device (e.g., the electronic device 101 of FIG. 1, the first electronic device 410 of FIGS. 4 and 5) and boosting level information is included, it may perform boosting for the destination process. The destination process is a process that processes the task requested by the external device 101. The destination process may be created according to execution of an application or service related to the external device 101, and whether it is related to the external device 101 may be preset.

In the following example, each operation may be performed sequentially, but is not necessarily performed sequentially. For example, the order of the operations may be changed, and at least two operations may be performed in parallel.

In operation 810, the electronic device 104 according to an embodiment may receive a boosting level message. The electronic device 104 may receive a boosting level message along with a data or task request message from the external device 101 through a communication process. The boosting level message may be transferred to a booster module of the electronic device 104 that performs CPU scheduling and/or CPU resource management. The boosting level message may indicate the priority, e.g., the processing importance of the process that requested the task or data from the external device 101. The higher the boosting level, the faster the processing of the corresponding task should proceed within the external device 101, and the task requested from the electronic device 104 in relation to the corresponding task may also be required to be processed quickly.

In operation 820, the booster module of the electronic device 104 according to an embodiment may determine whether the destination process that will process the task requested by the external device 101 has high relevance with processes running within the electronic device 104. The degree of relevance may be determined according to the relationship with the application or service that created each process. For example, the relevance between processes executed by the same application may be considered the highest. The relevance of processes executed by different applications may be considered the lowest. However, even when they are different applications, in case that they have an interaction with a calling relationship with each other, the relevance of the corresponding processes may be considered high.

In operation 830, based on determining that there is high relevance with running processes, the booster module of the electronic device 104 according to an embodiment may set the boosting level of the destination process equal to the boosting level of the running process.

In operation 840, based on determining that there is not high relevance with running processes, the booster module of the electronic device 104 according to an embodiment may determine whether the requested task is displayed to the user on the electronic device 104 or the external device 101. Being displayed to the user may represent, e.g., a process output through a display. For example, the process that requested the task from the external device 101 may be in a foreground state, or the destination process of the electronic device 104 may be in a foreground state.

In operation 850, in case that the booster module of the electronic device 104 according to an embodiment identifies that there is not high relevance with running processes but the requested task is displayed to the user, it may set the boosting level of the destination process equal to the boosting level of real-time level processes. Real-time level processes may have a priority level capable of real-time processing. For example, in case that the operating system adjusts CPU scheduling priority by assigning NICE values in a predetermined range, the booster module may set the same NICE value as real-time level processes to the destination process.

In operation 860, in case that there is not high relevance with running processes and the requested task is not displayed to the user, the booster module of the electronic device 104 according to an embodiment may set the boosting level of the destination process lower than the boosting level of real-time level processes. The booster module may set a lower NICE value than real-time level processes to the destination process.

As such, the electronic device 104 may determine the degree of boosting level for the destination process according to the request of the external device 101, considering the priority of running processes.

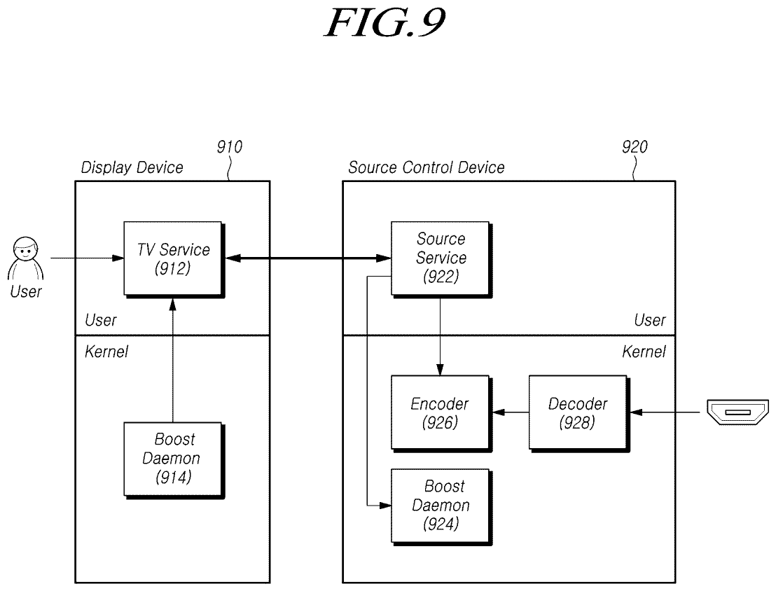

FIG. 9 is a diagram illustrating an example CPU scheduling adjustment operation between a display device and a source control device according to various embodiments.

A display device 910 (e.g., the electronic device 101 of FIG. 3) and a source control device 920 (e.g., the external device 104 of FIG. 3) according to an embodiment may interact with each other and provide a single integrated service (e.g., TV service) to a user. For example, the display device 910 may execute a TV service 912 that displays TV content according to a user input. In case that a boost daemon 914 of the display device 910 applies boosting to the TV service 912, a process communicating with an API requested by the TV service 912 may receive boosting application through priority inheritance. The TV service 912 of the display device 910 may interact with a source service 922 of the source control device 920. For example, in response to a first source data request from the TV service 912, the source service 922 may transmit first source data. The source service 922 may be related to an encoder 926 and a decoder 928. A boost daemon 924 of the source control device 920 may apply boosting to the source service 922 at the request of the TV service 912, and enable the encoder 926 and decoder 928 related to the source service 922 to receive boosting application through priority inheritance. In case that the TV service 912 requests data from the source service 922, it may include the boosting state in the boost message and transmit them together. The source service 922 may receive the boost message and transfer boosting state information of the TV service 912 to the boost daemon 924. Although the display device 910 and the source control device 920 correspond to systems operated by separate operating systems, by transmitting the boosting state of the requesting process together in case of requesting a service or data, they may have the same effect as priority inheritance boosting operating within a single system.

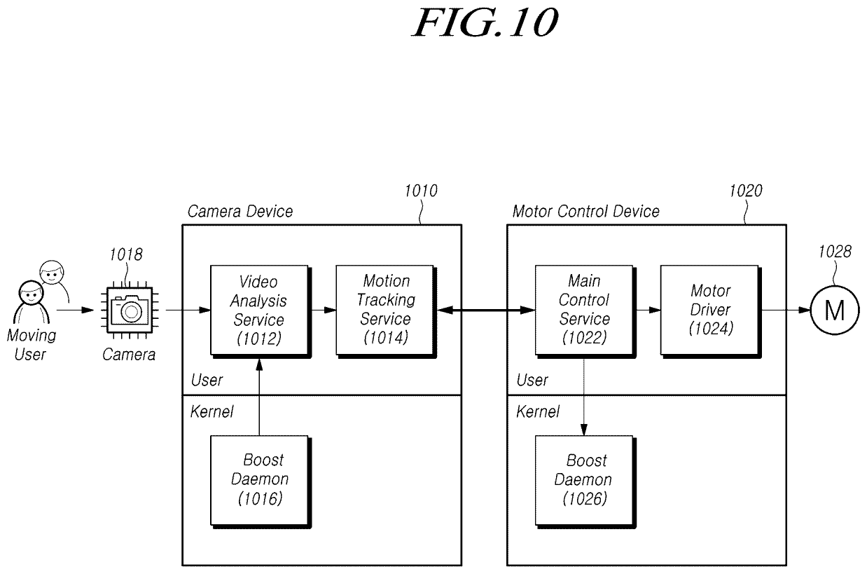

FIG. 10 is a diagram illustrating an example CPU scheduling adjustment operation between a camera device and a motor control device according to various embodiments.

A camera device 1010 (e.g., the electronic device 101 of FIG. 3) and a motor control device 1020 (e.g., the external device 104 of FIG. 3) according to an embodiment may interact with each other and provide a single integrated service (e.g., a robot that follows a moving user) to a user. Although the camera device 1010 and the motor control device 1020 correspond to separate systems, based on information tracking a user's movement through a camera 1018 of the camera device 1010, a motor 1028 of the motor control device 1020 may be controlled in real-time to enable the motor control device 1020 to follow the user's movement. In this case, the camera device 1010 may be worn by the user. For example, the camera device 101 may be an HMD or a glasses-type wearable device.

A motion tracking service 1014 of the camera device 1010 may transmit/receive real-time data with a main control service 1022 of the motor control device 1020 through a network. Although they correspond to external systems to each other, they may transmit the boosting state of the corresponding service together in case of requesting data or a task. A video analysis service 1012 may analyze real-time images obtained through the camera 1018. The video analysis service 1012 may transfer analyzed real-time image information to the motion tracking service 1014 to track the user's movement. A boost daemon 1016 of the camera device 1010 may apply boosting to the video analysis service 1012 that requires real-time processing. The boosting applied to the video analysis service 1012 may also be priority-inherited to the related motion tracking service 1014 to enable fast operation.

The motion tracking service 1014 may transmit the current boosting level of the motion tracking service 1014 together while transmitting user movement information to the main control service 1022. The main control service 1022 may transmit boosting information to a booster module 1026, and the booster module 1026 may apply boosting to the main control service 1022 that received the task request. The main control service 1022 may generate a motor control signal based on user movement information in a boosting state and drive the motor 1028 through a motor driver 1024.

As such, although the motion tracking service 1014 and the main control service 1022 are running on different devices, by transmitting boosting state information in case of requesting data or a task through network communication, they may have the same effect as priority inheritance boosting operation within a single system. In case that fast response or processing is required even for interaction between heterogeneous devices, fast response or processing may be expected by directly requesting CPU scheduling of the counterpart device.

The various example embodiments of the disclosure and terms used therein are not intended to limit the technical features described in the disclosure to specific embodiments, and should be understood to include various modifications, equivalents, or substitutes of the various embodiments. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit;
a memory including at least one storage medium storing instructions; and
at least one processor, comprising processing circuitry, wherein at least one processor, individually and/or collectively, is configured to execute the instructions and to cause the electronic device to:
identify that a first task request for an external device occurs in a first process according to execution of a first application;
based on determining that a CPU priority of the first process is higher than a threshold level, generate, a boost message including CPU priority information of the first process; and
transmit, through the communication circuit, the first task request and the boost message to the external device.

2. The electronic device of claim 1, wherein at least one processor, individually and/or collectively, is configured to cause the electronic device to:
identify a boosting level of the first process through a boost daemon configured to perform CPU scheduling or CPU resource management of the electronic device; and
include the boosting level in the boost message.

3. The electronic device of claim 1, wherein at least one processor, individually and/or collectively, is configured to cause the electronic device to set the boost message to be transmitted to a boost daemon configured to perform CPU scheduling or CPU resource management of the external device.

4. The electronic device of claim 1, wherein at least one processor, individually and/or collectively, is configured to cause the electronic device to, based on the first task not requiring a response from the external device, set to include a timeout event in the boost message.

5. The electronic device of claim 1, wherein at least one processor, individually and/or collectively, is configured to cause the electronic device to, based on the first task requiring a response from the external device, set generation of a response according to completion of the first task as a de-boosting condition in the boost message.

6. The electronic device of claim 1, wherein at least one processor, individually and/or collectively, is configured to cause the electronic device to:
after transmitting the first task request message, based on determining that the first task request is not needed, generate a de-boost message configured to release a previous boost message; and
transmit the de-boost message to the external device through the communication circuit.

7. The electronic device of claim 1, wherein at least one processor, individually and/or collectively, is configured to cause the electronic device to transmit the first task request and the boost message based on any one method of DBUS, KDBUS, socket, or global remote procedure call (gRPC).

8. An electronic device comprising:
a communication circuit;
a memory including at least one storage medium storing instructions; and
at least one processor, comprising processing circuitry, wherein at least one processor, individually and/or collectively, is configured to execute the instructions and to cause the electronic device to:
receive, through the communication circuit, a first task request including a boost message from an external device;
identify a second process of a second application to process the first task, and transfer the first task request to the second process;
transfer the boost message to a boost daemon configured to perform CPU scheduling or CPU resource management;
allow the boost daemon to apply boosting to the second process based on determining that a boosting level included in the boost message is higher than a threshold level; and
allow the second process to process the first task.

9. The electronic device of claim 8, wherein at least one processor, individually and/or collectively, is configured to cause the electronic device to allow the boost daemon to not apply boosting to the second process based on determining that the boosting level included in the boost message is not higher than the threshold level.

10. The electronic device of claim 8, wherein at least one processor, individually and/or collectively, is configured to cause the electronic device to:
based on the second application not running, execute the second application; and
register the second process as related to the external device.

11. The electronic device of claim 8, wherein at least one processor, individually and/or collectively, is configured to cause the electronic device to:
based on a timeout event being included in the boost message, allow the timeout event to proceed from a time at which the boosting operation of the second process is performed; and
in response to completion of the timeout event, release the boosting operation of the second process.

12. The electronic device of claim 8, wherein at least one processor, individually and/or collectively, is configured to cause the electronic device to, in response to the second process processing the first task and generating a response, release the boosting operation of the second process.

13. The electronic device of claim 8, wherein at least one processor, individually and/or collectively, is configured to cause the electronic device to:
receive a de-boost message for the first task request from the external device through the communication circuit;
transfer the de-boost message to the boost daemon; and
allow the boost daemon to release the boosting operation of the second process in response to receiving the de-boost message.

14. The electronic device of claim 8, wherein at least one processor, individually and/or collectively, is configured to cause the electronic device to receive the first task request including the boost message based on any one method of DBUS, KDBUS, socket, or gRPC.

15. The electronic device of claim 8, wherein at least one processor, individually and/or collectively, is configured to cause the electronic device to:
determine whether the second process has high relevance with currently running processes; and
in response to determining that the second process has high relevance with the currently running processes, set the boosting level of the second process equal to the boosting level of the running process.

16. The electronic device of claim 15, wherein at least one processor, individually and/or collectively, is configured to cause the electronic device to:
in response to determining that the second process does not have high relevance with currently running processes, determine whether the first task is displayed to a user; and
in response to determining that the first task is displayed to the user, set the boosting level of the second process equal to the boosting level of real-time level processes.

17. The electronic device of claim 16, wherein at least one processor, individually and/or collectively, is configured to cause the electronic device to, in response to determining that the first task is not displayed to the user, set the boosting level of the second process lower than the boosting level of real-time level processes.

18. A non-transitory computer-readable storage medium storing at least instruction, wherein the at least one instruction, when executed by at least one processor, comprising processing circuitry, of an electronic device, individually and/or collectively, causes the electronic device to perform operations comprising:
identifying occurrence of a first task request for an external device in a first process according to execution of a first application;
based on determining that a CPU priority of the first process is higher than a threshold level, generating a first boost message including CPU priority information of the first process; and
transmitting the first task request and the first boost message to the external device.

19. The non-transitory computer-readable storage medium of claim 18, wherein the storage medium further includes instructions which, when executed by at least one processor of the electronic device, individually and/or collectively, causes the electronic device to perform operations comprising:
identifying a boosting level of the first process through a boost daemon performing CPU scheduling or CPU resource management of the electronic device; and
including the boosting level in the first boost message.

20. The non-transitory computer-readable storage medium of claim 18, wherein the storage medium further includes instructions which, when executed by at least one processor of the electronic device, individually and/or collectively, causes the electronic device to perform operations comprising:
receiving a second task request including a second boost message from another external device;
identifying a second process of a second application to process the second task, and transferring the second task request to the second process;
transferring the second boost message to a boost daemon configured to perform CPU scheduling or CPU resource management of the electronic device;
applying, by the boost daemon, boosting to the second process based on determining that a boosting level included in the second boost message is higher than a threshold level; and
processing by the second process the second task.
